(19) United States
(12) Patent Application Publication
(10) Pub. No.: US 2005/0038182 A1
(43) Pub. Date: Feb. 17, 2005

(54) Wood products and processes for the preparation thereof

(75) Inventors: Branko Hermescec, Dandenogn (AU); Neli Drvodelic, Mt. Waverly (AU); Barry Shearer, Ballarat (AU); David Butt, Parkville (AU); Brett Skewes, Parkville (AU)

Correspondence Address: David J. Brezner;Dorsey & Whitney LLP, Intellectual Property Department, Four Embarcadero Center, Suite 3400, San Francisco, CA, 94111-4187, US

(73) Assignee: The University of Melbourne

(21) Appl. No.: 10/823,523

(22) Filed: Apr. 12, 2004

Related U.S. Application Data
(63) Continuation of application No. PCT/AU01/01558, filed on Nov. 30, 2001.

(30) Foreign Application Priority Data
Dec. 1, 2000 (AU) PR1831

(51) Int. Cl. C08F 4/06

(52) U.S. Cl. 524/593; 526/221

(57) ABSTRACT

A process for treating wood comprising: a) impregnating the wood with a solution of furfuryl alcohol; b) allowing the impregnated wood to sit so as to permit diffusion of the furfuryl alcohol solution into the wood; and hot pressing the wood under conditions to effect polymerization of the furfuryl alcohol within the wood.

The present invention relates to wood products and processes for the preparation thereof. In particular, the invention relates to processes for treating wood with a solution of furfuryl alcohol, and to processes for the preparation of a composite wood product using a solution of furfuryl alcohol.

The treatment of wood to improve performance characteristics, such as structural and engineering characteristics, of the wood is known. In particular, the densification of wood is not a new idea. Different trials have been done in the past to produce two main products. One is a dimensionally stable untreated compressed wood, commonly called “Staypak”, and the other are resin treated compressed board called “Compreg”. These products have found a specialist use, and have been marketed in these areas.

“Staypak” is hardwood compressed in a fashion that allows the lignin to flow sufficiently between the cellulose fibers to eliminate internal stresses. This is most probably done through heating the wood to a predetermined temperature, compressing and holding for a set amount of time. It is possible to create stable dimensions in this fashion. “Staypak” has increased water resistance, impact resistance, and flexural strength properties, but has little positive effect on weathering.

“Compreg” is layers of hardwood veneer treated with phenol-formaldehyde resin and compressed to around 1350 kg/m³. The resin cures in this environment and forms as a holding and bulking agent within the wood to stabilise the wood. This form of treatment has a negative effect on impact strength, but increases water resistance, hardness, and flexural strength. Many novel end uses were found for “Compreg”, but it has little or no use today.

Separate work has also been done in the Soviet Union on wood densification. A stable, high-density product was produced, but dimensional stability was not achieved. No product was found that successfully bound the wood in a fixed structure at high density, or prevent water uptake. A potential limitation to these products is the use of hardwoods. Generally hardwoods are a more expensive raw product, while Radiata pine is a very cheap wood in comparison. Radiata pine sapwood is also very permeable, and the low density allows for large uptakes of solution within the wood. The problem with not chemically modifying the wood is that there is little that can be done to improve a wide range of characteristics, especially dimensional stability.

The production of composite materials using binders, such as formaldehyde are also known. Normally, in such conventional processes, the wood must be dried to a moisture content of from about 2-3% (based on the dry weight of the wood), due to the presence of water in the binder. Furthermore, binders such as formaldehyde are known carcinogens and, therefore, have associated health and safety concerns.

The processes of the present invention advantageously provide for the manufacture of treated wood products and composite wood products which avoid the use of formaldehyde, and which further advantageously provide wood products and composite materials with improved performance characteristics compared with the wood products and composite materials of the prior art.

According to a first aspect of the present invention there is provided a process for treating wood comprising:
a) impregnating the wood with a solution of furfuryl alcohol;
b) allowing the impregnated wood to sit so as to permit diffusion of the furfuryl alcohol solution into the wood; and
c) hot pressing the wood under conditions to effect polymerisation of the furfuryl alcohol within the wood.

It is believed that the above process, wherein the furfuryl alcohol solution is allowed to diffuse into the wood facilitates diffusion into the cell walls of the wood, thus blocling hydroxyl groups of the cellulose. As such, on hot pressing of the impregnated wood, a chemical adhesive bond is formed in a three-dimensional array in the wood, thus providing the treated wood with improved performance characteristics.

The furfuryl alcohol solution preferably includes an additive to facilitate the polymerisation reaction during hot pressing. In a particularly preferred embodiment, the furfuryl alcohol solution includes furfuryl alcohol and maleic acid. So that the maleic acid may be dissolved in the furfuryl alcohol, the solution preferably further comprises water, most preferably in an amount of about 5% by volume.

The impregnation step a) is conducted so to facilitate chemical loading of the wood, preferably at a loading of from about 15% to 30% (based on the dry weight of the wood). In a preferred embodiment, the impregnating step a) comprises applying an initial vacuum to the wood followed by the application of pressure in the presence of the furfuryl alcohol solution. Preferably, the vacuum is applied at a pressure of from −90 to −95 kPa. Preferably, the pressure applied to the wood to facilitate impregnation of the furfuryl alcohol solution is from about 200 to about 1,000 kPa, more preferably at least 300 kpa.

The diffusion step b) is preferably conducted over a period of from about 3 to 5 days at ambient pressure and temperature. The diffusion step b) is preferably such that the wood swells up to about 22% per volume relative to the volume of the original wood sample. It will be understood by those in the art that the amount of swelling of the wood will be somewhat dependent on the density of the wood and that denser wood may be expected to swell more than less dense wood.

The hot pressing step c) is conducted under conditions which will effect polymerisation of the furfuryl alcohol, advantageously resulting in a three-dimensional chemical adhesive bond between the wood fibers. Preferably, the hot pressing step c) is conducted at a pressure of from about 5-30 MPa and a temperature of from about 170-200° C. Preferably, the hot pressing step is conducted for a period of from about 5-15 minutes. Such conditions result in the compression of the microstructure of the wood and trigger the polymerisation reaction of the furfuryl alcohol.

The process of this aspect of the invention may be carried out on any permeable timber including sap wood or soft wood, such as radiata pine. Furthermore, the process may be applied to less permeable woods to which has been applied a pretreatment to increase the permeability of the wood. Such pretreatments may include, for example, microwave or steam treatments.

There is also provided wood when treated by the process according to this aspect of the invention.

According to another aspect of the invention there is provided a wood product including wood which has been impregnated with a furfuryl alcohol solution, the wood product having enhanced strength and elasticity characteristics relative to the untreated wood.

In a particular embodiment, the wood product has a crushing strength of at least 50 MPa, a modulus of elasticity of at least 35 GPa and a hardness of at least 25,000 N. More preferably, the wood product has a modulus of elasticity of from 35-40 GPa and a hardness of from 25,000 to 30,000 N.

The wood product described above, or wood when treated by the process of the first aspect of the invention advantageously can be sanded or cut into desirable dimensions or shapes. Furthermore, advantageously the wood product does not absorb significant amounts of moisture, generally below 6% (based on the weight of the wood product). In this regard, the absorbence of moisture is generally not into the wood cell and, as such, the wood product does not exhibit any substantial amount of swelling or shrinkage during a soaking and drying cycle.

The high modulus of elasticity represents a substantial increase compared with that of the untreated wood. In particular, typically the parent wood would have a modulus of elasticity of between 5-6 GPa, compared with that of the treated wood of 35-40 GPa. Similarly, the hardness of the wood product of the invention is significantly higher than that of the parent wood, and is typically much higher than that of any hardwood which is currently available. For example, jarrah has a hardness of around 7000 N, which is much less than that which may be provided according to this aspect of the invention.

Still further, the wood product of the invention demonstrates high fire resistance, typically in the range of 85-90% of the values which may be expected for fully loaded boron wood. It is also noted that, in general terms, boron can not be successfully fixed to wood, and is thus typically lost from treated wood. In engineering terms, the wood product is structurally sound. Similarly, in economic terms, the production of the wood product, for example using the process for treating wood described above, is cost effective in that soft wood material may be treated to provide a replacement for the more expensive hardwood materials.

In conducting the present invention, it has also been found that furfuryl alcohol may provide significant advantages when used in the production of various wood based composite materials.

Accordingly, in a second aspect the present invention provides a process for preparing a wood based composite material comprising:
a) blending wood particles with a solution of furfuryl alcohol and furfuryl aldehyde; and
b) hot pressing the blended wood under conditions to effect polymerisation of the furfuryl alcohol to facilitate adhesion of the wood particles.

As used herein, the term “wood particles” includes wood chips, fibers, particles and the like.

Preferably, the solution of furfuryl alcohol and furfuryl aldehyde comprises an additive, most preferably maleic acid, and water. In one embodiment where maleic acid is the additive, water is added in an amount of 5% by volume, based on the volume of the solution, to facilitate dissolution of the maleic acid in the solution.

In accordance with this aspect of the invention, it is preferable that the blending of the wood particles with the solution of furfuryl alcohol and furfuryl aldehyde be conducted so that there is no significant penetration of the solution into the wood. That is, there is no substantial impregnation of the wood particles with the solution. Rather, the blending is preferably such that the solution is blended onto to the surfaces of the wood particles. For example, blending may be conducted using spinning discs.

To facilitate the blending and ensure that the wood particles are substantially coated with the furfuryl alcohol and furfuryl aldehyde solution, the viscosity of the solution may be adjusted prior to blending. Preferably, the viscosity of the solution is from 150 to 200 centipoise. If required, the solution may be prereacted in a vat to provide the desired viscosity. For example, the solution may be prereacted at temperatures of from about 50-60° C., typically for periods of about half an hour.

The hot pressing step b) according to this aspect of the invention will generally involve lower pressures than those used in the preparation of the wood product described earlier. This is due to the fact that a composite is being produced rather than a solid wood product. As such, in a preferred embodiment, the hot pressing step b) comprises the application of a pressure of from about 6-8 MPa.

The composite board produced by the above process advantageously has a density of at least about 700 kg/m³. Furthermore, as the furfuryl alcohol/furfuryl aldehyde solution contains little water, the water content of the initial wood particles may be relatively high compared with that used in conventional processes for the preparation of composite materials. For example, conventional processes generally require predrying of the wood to a water content of from about 2-3% by weight (based on the dry weight of the wood) due to the presence of water in the binder being used. According to the inventive process for preparing the composite material described herein, the wood particles may have a water content of, for example, up to about 10% by weight (based on the dry weight of the wood). Still further, as a result, the process according to the invention is faced with less problems resulting from gas emissions during processing compared with the conventional processes for preparing particle board and MDF board.

Accordingly, there is also provided a composite material when prepared by the process as described here above.

According to another aspect of the invention there is provided a composite material comprising wood particles which are chemically adhered with a binder solution of furfuryl alcohol and furfuryl aldehyde, preferably a binder solution which comprises furfuryl alcohol, furfuryl aldehyde, an additive such as maleic acid and water.

The following examples are provided for exemplification only and should not be construed as limiting on the invention in any way.

Samples of approximate size 18×45×200 of Radiata pine sapwood were used in this example. Samples were treated in a designed treatment tray to minimize the amount of treatment solution required. A modified Bethell process was used to produce required uptakes using the following treatments:

1. A Boron Mixture used under the following treatment schedule for large uptake:

Initial Vacuum-85 kPa for 15 minutes.
Pressure of 1200 kPa for 45 minutes.
Release pressure, and remove wood samples from treatment solution.
Put samples into empty tray, and back into treatment plant.
Final vacuum of −50 kPa for 20 minutes.
   2. Furfuryl alcohol composed of:
90% Furfuryl Alcohol
5% Maleic Acid (Catalyst)
5% Water (Assist Catalyst)
used under the following treatment schedule:
Vacuum of −70 kPa for 10 minutes.
Soak for 30 minutes.
Stand for 34 days to allow diffusion to occur.
   3. Control samples, some to be compressed, and some left in its original form.

The press and two moulds were preheated to 175° C. before a sample was placed in each mould. The mould lids were inserted on top of the samples and pressed for 10 minutes. The press has a maximum of 18000 kPa, and the surface area of the mould lids is 200 cm², therefore the maximum pressure is 90 kPa/cm².

The samples were then removed from the moulds, cooled and sanded to produce the end product. A problem was discovered when pressing the wood blocks. The wood increased in width freely as pressure was increased. As a result the end product was undesirable.

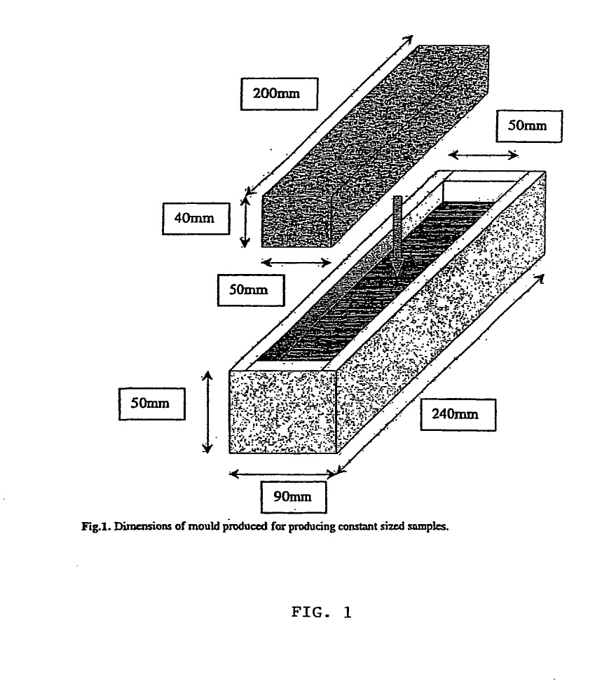

The end product was uncontrollable and for testing, uniform size samples were required. As a result a containing device was developed (FIG. 1). The wood is placed in the mould, the lid placed on top of the wood, and then pressed. As the wood compresses, the top of the lid becomes the same height as the sides of the mould. Once this point is reached, no more compression can occur, and the wood sample is of a predetermined size, shape and density, and can be readily reproduced. Made from flat, mild steel, the mould contains the wood producing a constant end product. The dimensions can be changed by inserting extra flat steel into the mould, and by changing the thickness of the “lid”.

An increase in density was achieved in this trial. Table 1 displays the final density of each sample and the average density of each treatment type.

TABLE 1
Final densities of each sample.

| | | | | Furfuryl |
|---|---|---|---|---|
| Sample | Uncompressed | Compressed | Boron Treated | Alcohol |
| No. | Controls | Controls | Compressed | Compressed |
| 1 | 454 | 1296 | 1121 | 1415 |
| 2 | 523 | 1181 | 983 | 1359 |
| 3 | 513 | 1171 | 1155 | 1336 |
| Mean | 497 | 1216 | 1086 | 1370 |

Table 2 displays the densities of the samples through each stage of the process, and shows the increase in density from the initial stage, to the final product.

TABLE 2
Density changes throughout treatment process.

| Sample | Initial | Post Treatment | Final | Density Increase |
|---|---|---|---|---|
| No. | Density | Density When Dry | Density | From Initial |
| C1 | 514 | | 1296 | 2.5 |
| C2 | 485 | | 1181 | 2.4 |
| C3 | 470 | | 1170 | 2.5 |
| B1 | 483 | 561 | 1121 | 2.3 |
| B2 | 482 | 527 | 983 | 2.0 |
| B3 | 470 | 575 | 1155 | 2.5 |
| F1 | 480 | 691 | 1415 | 2.9 |
| F2 | 451 | 632 | 1357 | 3.0 |
| F3 | 485 | 695 | 1336 | 2.7 |

C=Compressed Control, B=Boron Samples, F=Furfuryl Alcohol Samples.

Observation of these results shows that the Furfuryl alcohol samples had definite greater density increase than the compressed controls and Boron samples.

Three replicates of each sample type were produced and tested for MOE on a laboratory strength-testing machine. The formula for MOE is:

$$\frac{{WI}^{3}}{4 Δ b {d}^{3}}$$

Where:
W=Load (N)
I=Span (length of sample)
Δ=Deflection
b=Width of sample
d=Thickness of sample
   Now:
Slope=W/Δ
Therefore:

$$\frac{Slope \times {i}^{3}}{4 {bd}^{3}}$$

The dimensions were taken, and data gained from the strength-testing machine. The results were then calculated using the above formula.

| Treatment Type | Approximate Dimensions |
|---|---|
| Uncompressed Control | 200 × 45 × 16 mm |
| Compressed Control | 200 × 45 × 6 mm |
| Compressed Boron Treatment | 200 × 50 × 6 mm |
| Compressed with Furfuryl Alcohol | 200 × 50 × 6 mm |

The individual results of each sample are displayed in Table 3.

TABLE 3
MOE values for each sample.

| | | | Boron | |
|---|---|---|---|---|
| Sample | Uncompressed | Compressed | Treatment | Furfuryl |
| No. | Control (MPa) | Control (MPa) | (MPa) | Alcohol (MPa) |
| 1 | 7689 | 28092 | 27138 | 36468 |
| 2 | 8663 | 25708 | 20768 | 29818 |
| 3 | 8371 | 22980 | 33449 | 30507 |
| Mean | 8241 | 25593 | 27118 | 32264 |

Analysis of the results clearly shows a dramatic rise of MOE in the compressed samples. The mean results of the compressed samples have a MOE three to four times higher than the uncompressed control. Of the compressed samples there is also some difference in results. The treated samples have a higher MOE than the untreated samples, and the Furfuryl alcohol samples clearly gave the highest results.

Koehler (1924) generalized that the MOE increases directly with density increase. Table 4 shows the mean increases of density of MOE, and then the proportionate MOE increase with density.

TABLE 4
Mean increase of MOE/Density.

| | Mean Density | Mean MOE | |
|---|---|---|---|
| | Increase | increase | MOE/Density |
| Control | 2.4 | 3.1 | 1.30 |
| Boron | 2.2 | 3.3 | 1.50 |
| Furfuryl | 2.7 | 3.9 | 1.45 |
| Alcohol | | | |

Observation of these results indicates that all the sample types have exceeded the generalization Koehler makes. The treated samples show a greater increase in MOE than the untreated samples.

Three replicates of each sample type were produced and tested for MOR on a laboratory strength-testing machine. The formula for MOR is:

$$\frac{3 WI}{2 {bd}^{2}}$$

Where:
W=Load (N)
I=Span (length of sample)
b=Width of sample
d=Thickness of sample

The dimensions were taken, and data gained from the strength-testing machine. The results were then calculated using the above formula.

The MOR data for the samples is displayed in Table 5, and all data in Appendix 3.

TABLE 5
MOR values for each sample.

| | | | | Furfuryl |
|---|---|---|---|---|
| Sample | Uncompressed | Compressed | Boron Treated | Alcohol |
| No. | Control (GPa) | Control (GPa) | (GPa) | (GPa) |
| 1 | 71.4 | 251.5 | 130.3 | 219.8 |
| 2 | 104.2 | 171.1 | 116.5 | 144.3 |
| 3 | 114.4 | 175.0 | 119.6 | 202.3 |
| Mean | 96.6 | 119.2 | 122.2 | 188.8 |

Analysis of the results shows an increase of MOR values in the compressed samples. The mean results of the compressed samples have a MOE 1.3 to 2.1 times higher than the uncompressed control. Of the compressed samples there is also some difference in results. The control samples have a higher MOE than the treated samples.

The MOR increases slightly more rapidly than the density. This has not been the case for this series of samples. As seen in Table 6 the density has increased at a higher rate than the MOR in all sample types. The controls were close to 1:1, but the treated samples, especially the Boron treated samples gave negative results in comparison to the controls.

It has been found that the MOR of compressed untreated wood (StayPak), has a marginally higher MOR than uncompressed wood, and the resin treated compressed wood (Compreg), actually has a lower MOR than uncompressed, untreated wood. So in comparison to these results, the MOR of our samples appears quite good.

TABLE 6
Mean increase of MOR/Density.

| | Mean Density | Mean MOR | |
|---|---|---|---|
| | Increase | Increase | MOR/Density |
| Control | 2.4 | 2.1 | 0.95 |
| Boron | 2.2 | 1.3 | 0.60 |
| Furfuryl Alcohol | 2.7 | 1.9 | 0.75 |

Hardness test were also conducted on samples approximately 17×50×200 mm in size as uncompressed controls, compressed controls, and Furfuryl alcohol treated samples. Initial trials on thinner samples failed due to breakage, therefore no meaningful results could be gained. Therefore, it was necessary to produce new thicker samples, but due to material and time constraints, the Boron treated samples.

The results are displayed in Table 7. The results are difficult to analyze due to incomplete results with the Furfuryl alcohol samples, although it is possible to gain some indications from the results. The compressed samples had a much higher surface hardness than the uncompressed samples as expected. The Furfuryl alcohol samples have a higher hardness than the compressed controls. These are the only clear results to be gained.

TABLE 7
Results of hardness trial, and density of each sample.

| | | | | | Average | Average |
|---|---|---|---|---|---|---|
| Sample | Den- | Hardness | | | Density | Hardness |
| No. | sity | Test 1 | Test 2 | Test 3 | Increase | Increase |
| U1 | 454 | 2252 | 2608 | 2520 | | |
| U2 | 523 | 2728 | 2792 | 2988 | | |
| C1 | 1025 | 7190 | 7760 | 8350 | 2.1 | 2.9 |
| C2 | 982 | 6938 | 7140 | 7200 | 2.0 | 2.7 |
| F1 | 1265 | 10000 @ | 10000 @ | 10000 @ | 2.6 | >3.7 |
| | | 3.3 | 2.9 | 2.8 | | |
| F2 | 1312 | 10000 @ | 10000 @ | 10000 @ | 2.7 | >3.7 |
| | | 3.25 | 2.8 | 2.4 | | |

The density is displayed to show how the density increase, produces an increase in hardness. Koehler (1924), stated that in general the hardness increase is approximately the square of the density. Therefore a density increased by a factor of 2, should produce a hardness increase of approximately 4. Observation of the control samples, show that the hardness increase is not as high as expected, but it is hard to tell with the Furfuryl alcohol samples. The hardness “ball” needs to penetrate 5.6 mm into the wood surface, but this was not achieved with the strength-testing machine used. The strength-testing machine has a maximum force of 10,000 N, so the depth of penetration was recorded when the maximum force was reached. As can be seen in Table 7 there was still a large amount of penetration to occur before the 5.6 mm mark was reached, therefore the hardness values would actually be much higher.
3 replicates of each type of sample:
30×30×6 mm for compressed samples
30×30×1 6 mm for uncompressed controls
   were produced for dimensional stability testing.

All samples were dried at 105° C. for 24 hours to produce a known starting point. Each sample was weighed and dimensions taken before exposure to water. Each sample type was placed in individual beakers of water. All samples were removed from the water, dried with paper, weighed, and dimensions taken at following time intervals:

5, 10, 15, 20, 30, 60, 180 minutes, and 24 hours.

When finished the samples were dried at 105° C. for 24 hours, weighed, and dimensions taken.

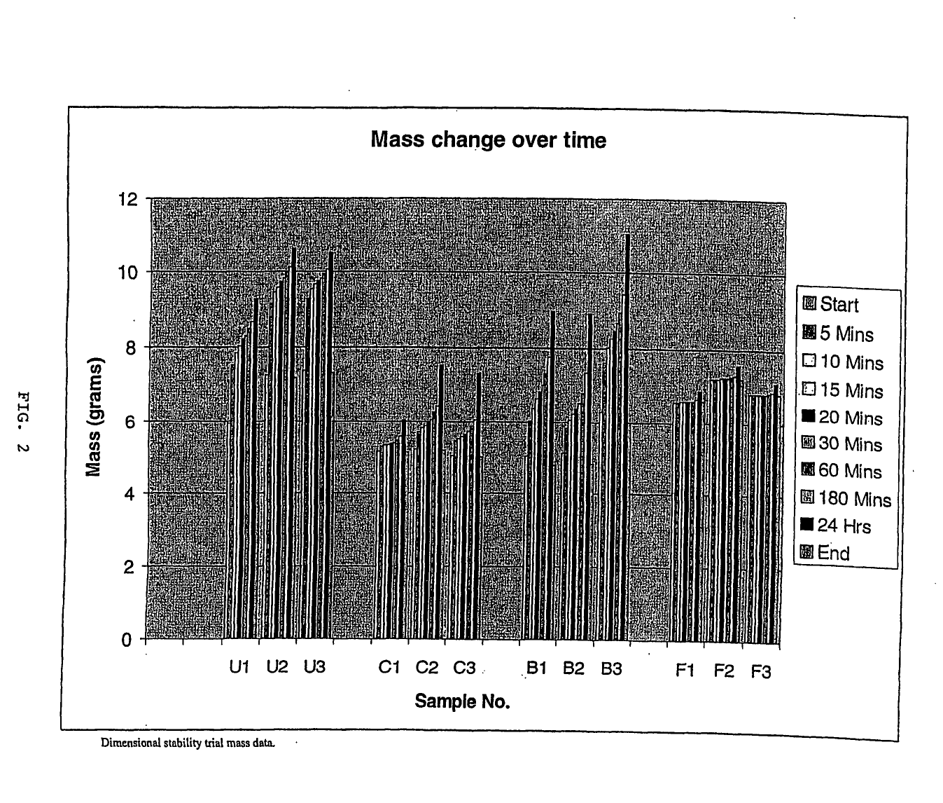

Displayed in FIG. 2 is the data for each individual samples mass change over time. A brief observation of this chart shows that there was steady mass increase over time for all samples except the Furfuryl alcohol samples. Table 8 shows the percentage increase of mass from the starting point to 24 hours of soaking. The standout figure here is the very low percentage mass gain of the Furfuryl alcohol samples. On average there was only a 4.8% mass gain. The Boron treated samples had an average 76.4% mass gain over the 24-hour soaking period. The controls, and compressed controls had mass uptakes of 48.7% and 35.7% respectively.

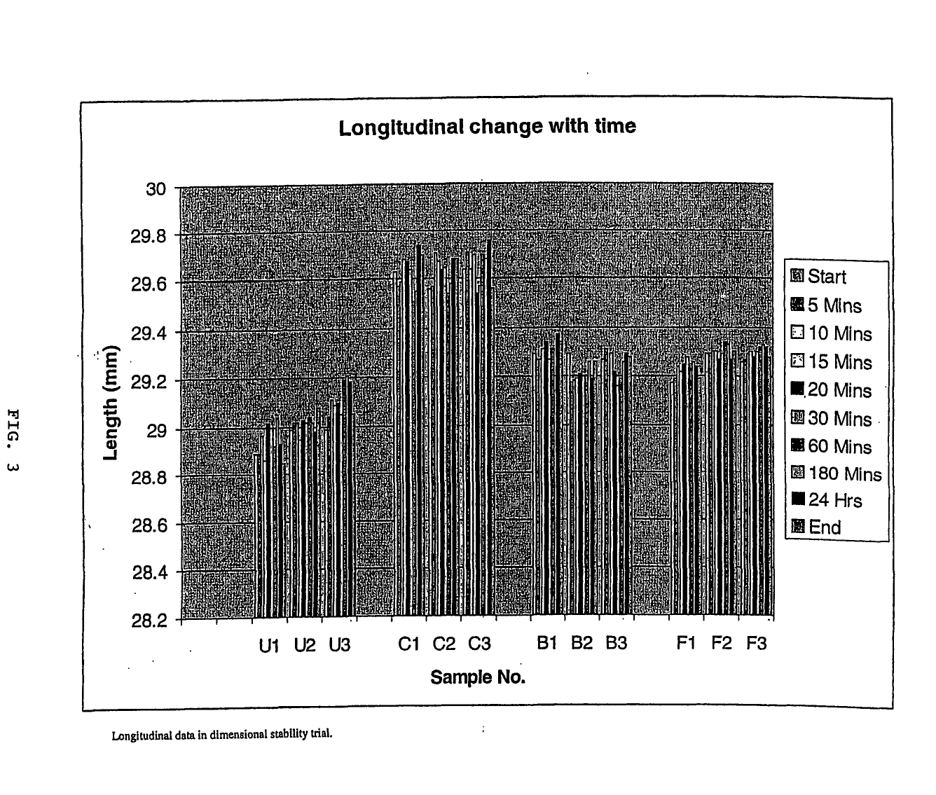

FIG. 3 displays all the data of the changes in the longitudinal direction. It is expected that in all samples there should be very little change during this trial, and this is what can be seen from observation of the results. Each sample keeps within a 0.3 mm range, and appears quite random with time. Some of this random nature can be explained by the use of the digital calipers, as it is impossible to be totally accurate when using manual means. If there can be any differences found between the samples, it is that the variation is slightly smaller in the Furfuryl alcohol samples.

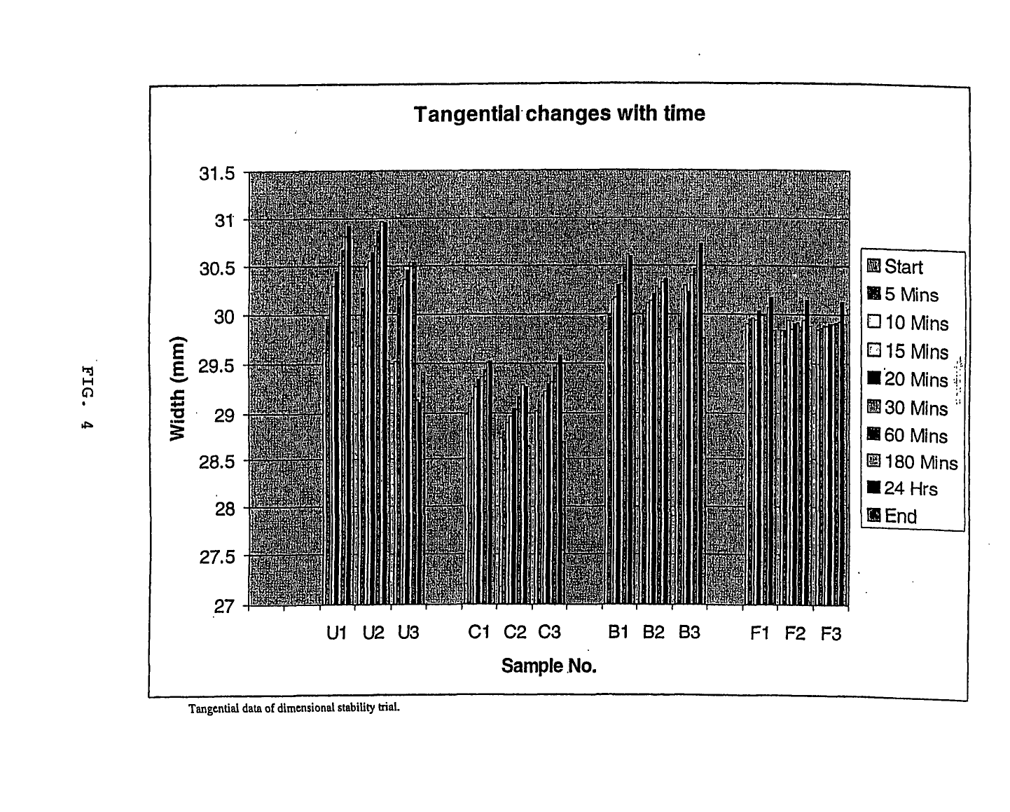

Observation of FIG. 4 shows that the tangential dimension changes have similar results to the mass change section previously discussed. Apart from the Furfuryl alcohol samples there is a clear steady increase over time in the other sample types. Table 8 gives the percentage increase from the start of the trial to the 24-hour mark. The percentage increase in the tangential direction for the controls, compressed controls and Boron treated samples are 2.4%, 1.9% and 2.3% respectively. The Furfuryl alcohol samples had an increase of 0.9% over 24 hours soaking time. This is the notable result to come from this section of the trial.

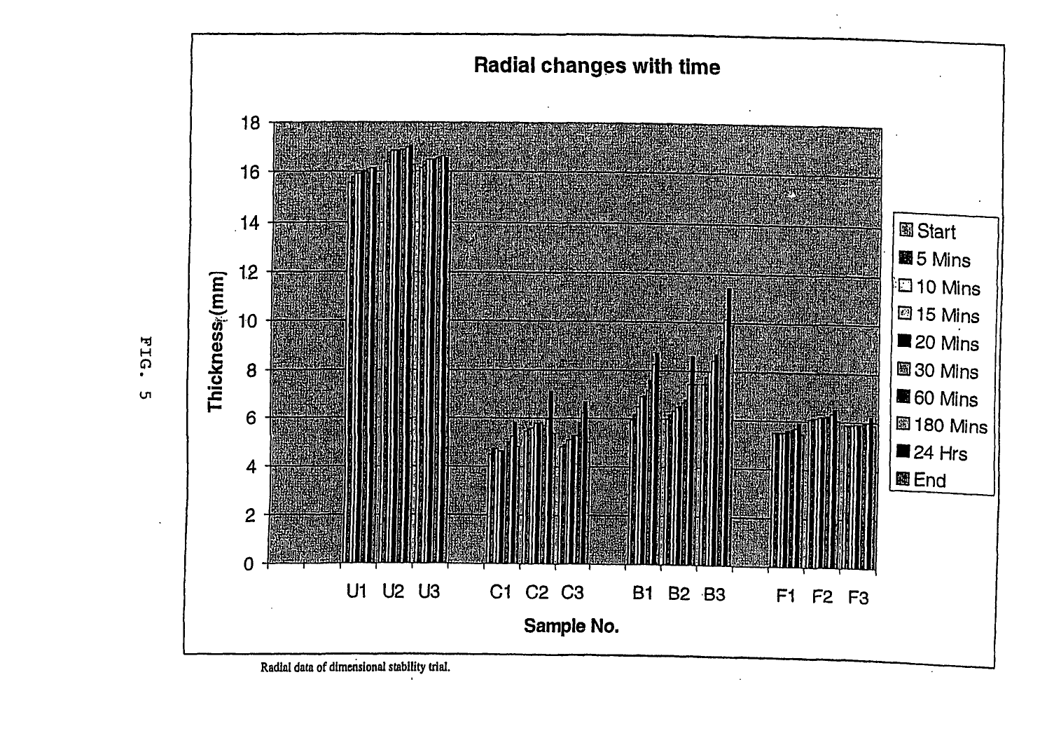

The last section analyzed is the dimension changes in the radial direction. The compressed samples are compressed in the radial direction, so this is the section where very notable results are expected. The data for each sample is shown in FIG. 2. It is expected that the compressed samples should swell at a much greater rate than the uncompressed samples, as there is much more cell wall material in the compressed samples. Observation of FIG. 5 shows high swelling in the compressed control and Boron treated samples, but less in the control and Furfuryl alcohol samples. Percentage increase over the 24-hour soaking period is again shown in Table 8. The controls had a dimension increase of 3.4% on average, which is fairly standard. The compressed controls and Boron treated samples had an increase of 33.1% and 47.4% respectively. As already noted this is due to the amount of cell wall material in the high-density product, and they were compressed approximately 130% when pressed. The Furfuryl alcohol samples, which had an average density of 1370 kg/M³, only had an average swelling of 6.7%. These are very encouraging results.

TABLE 8
% mass increase, % tangential increase, % radial
increase for dimensional stability trial.

| | | % Tangential | % Radial |
|---|---|---|---|
| Sample No. | % Mass Increase | Increase | Increase |
| U1 | 56.5 | 4.3 | 3.9 |
| U2 | 46.8 | 4.2 | 3.8 |
| U3 | 42.9 | −1.4 | 2.5 |
| Mean | 48.7 | 2.4 | 3.4 |
| C1 | 16.9 | 1.9 | 29.8 |
| C2 | 44.9 | 1.8 | 31.2 |
| C3 | 45.4 | 1.9 | 38.4 |
| Mean | 35.7 | 1.9 | 33.1 |
| B1 | 79.1 | 2.5 | 47.0 |
| B2 | 74.4 | 1.6 | 42.9 |
| B3 | 75.7 | 2.9 | 52.5 |
| Mean | 76.4 | 2.3 | 47.4 |
| F1 | 4.7 | 0.9 | 7.6 |
| F2 | 5.3 | 1.0 | 6.4 |
| F3 | 4.5 | 0.9 | 6.3 |
| Mean | 4.8 | 0.9 | 6.7 |

In all the four aspects of this trial the Furfuryl alcohol samples produced excellent results.

The other samples behaved fairly predictably, but it was the Furfuryl alcohol samples where the main interest was. The Furfuryl alcohol samples allowed minimal water into the wood, and also allowed minimal dimension change in very high-density wood. Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that that prior art forms part of the common general knowledge in Australia.

Those skilled in the art will appreciate that the invention described herein is susceptible to variations and modifications other than those specifically described. It is to be understood that the invention includes all such variations and modifications which fall within its spirit and scope. The invention also includes all the steps, features, compositions and compounds referred to or indicated in this specification, individually or collectively, and any and all combinations of any two or more of said steps or features.

1. A process for treating wood comprising:
a) impregnating the wood with a solution of furfuryl alcohol;
b) allowing the impregnated wood to sit so as to permit diffusion of the furfuryl alcohol solution into the wood; and
c) hot pressing the wood under conditions to effect polymerisation of the furfuryl alcohol within the wood.

2. A process according to claim 1, wherein the furfuryl alcohol solution includes an additive, preferably maleic acid, to facilitate polymerisation during hot pressing.

3. A process according to claim 2, wherein the furfuryl alcohol solution further comprises water, preferably in an amount of about 5% by volume.

4. A process according to claim 1, wherein the impregnating step a) comprises applying an initial vacuum to the wood followed by the application of pressure in the presence of the furfuryl alcohol solution.

5. A process according to claim 4, wherein the vacuum is applied at a pressure of from −90 to −95 kPa and wherein the pressure applied to the wood to facilitate impregnation of the furfuryl alcohol solution is from about 200 to about 1,000 kPa, preferably at least 300 kPa.

6. A process according to claim 1, wherein the diffusion step b) is conducted over a period of from about 3 to 5 days at ambient pressure and temperature.

7. A process according to claim 1, wherein the diffusion step b) is such that the wood swells up to about 22% per volume relative to the volume of the original wood sample.

8. A process according to claim 1, wherein the hot pressing step c) is conducted under conditions which will effect polymerisation of the furfuryl alcohol resulting in a three-dimensional chemical adhesive bond between the wood fibres.

9. A process according to claim 1, wherein the hot pressing step c) is conducted at a pressure of from about 5-30 MPa and a temperature of from about 170-200° C., preferably for a period of from about 5-15 minutes.

10. A process according to claim 1, including pretreating the wood to increase the permeability of the wood, preferably by microwave or steam treatments.

11. Wood when treated by the process according to claim 1.

12. A wood product including wood which has been impregnated with a furfuryl alcohol solution, the wood product having enhanced strength and elasticity characteristics relative to the untreated wood.

13. A wood product according to claim 12, having a crushing strength of at least 50 MPa, a modulus of elasticity of at least 35 GPa and a hardness of at least 25,000 N, preferably a modulus of elasticity of from 3540 GPa and a hardness of from 25,000 to 30,000 N and drying cycle.

14. A process for preparing a wood based composite material comprising:
d) blending wood particles with a solution of furfuryl alcohol and furfuryl aldehyde; and
e) hot pressing the blended wood under conditions to effect polymerisation of the furfuryl alcohol to facilitate adhesion of the wood particles.

15. A process according to claim 14, wherein the solution of furfuryl alcohol and furfuryl aldehyde comprises an additive, preferably maleic acid and water.

16. A process according to claim 15, wherein water is added in an amount of 5% by volume, based on the volume of the solution, to facilitate dissolution of the maleic acid in the solution.

17. A process according to claim 14, wherein the blending of the wood particles with the solution of furfuryl alcohol and furfuryl aldehyde is conducted so that there is no significant penetration of the solution into the wood, the wood particles being substantially coated with the furfuryl alcohol and furfuryl aldehyde solution.

18. A process according to claim 14, wherein the viscosity of the solution is from 150 to 200 centipoise.

19. A method according to claim 14, wherein the hot pressing step b) comprises the application of a pressure of from about 6-8 MPa.

20. A composite material when prepared by the process according to claim 14.

21. A composite material comprising wood particles which are chemically adhered with a binder solution of furfuryl alcohol and furfuryl aldehyde, preferably a binder solution which comprises furfuryl alcohol, furfuryl aldehyde, an additive such as maleic acid and water.
